(19) United States
(12) Patent Application Publication
(10) Pub. No.: US 2023/0411619 A1
(43) Pub. Date: Dec. 21, 2023

(54) METHOD FOR FORMING SECONDARY BATTERY AND NEGATIVE ELECTRODE ACTIVE MATERIAL LAYER

(71) Applicant: Semiconductor Energy Laboratory Co., Ltd., Atsugi-shi (JP)

(72) Inventors: Masayuki KIMURA, Atsugi (JP); Kenji ARAI, Isehara (JP); Taisuke NAKAO, Atsugi (JP); Kazutaka KURIKI, Ebina (JP)

(21) Appl. No.: 18/207,817

(22) Filed: Jun. 9, 2023

(30) Foreign Application Priority Data
Jun. 17, 2022 (JP) 2022-097849

(51) Int. Cl. H01M 4/583; H01M 10/0525; H01M 4/38; H01M 4/36; H01M 4/04

(52) U.S. Cl. CPC H01M 4/583; H01M 10/0525; H01M 4/386; H01M 4/364; H01M 4/04; H01M 2004/027

(57) ABSTRACT

A negative electrode active material, a negative electrode active material layer, and a secondary battery including them, or a formation method thereof are provided. In one embodiment of the present invention, carbon particles and a silicon-based material are mixed and used as a negative electrode active material. A polymer including a polar substituent such as a carboxy group is used as a binder. Specifically, as the binder for the carbon particles and the silicon-based material, a polymer containing glutamic acid is used. As the silicon-based material, nanosilicon particles each having a particle diameter less than 1 μm is used.

### BACKGROUND OF THE INVENTION

### 1. Field of the Invention

One embodiment of the present invention relates to an object, a method, or a manufacturing method. The present invention relates to a process, a machine, manufacture, or a composition of matter. One embodiment of the present invention relates to a power storage device including a secondary battery, a semiconductor device, a display device, a light-emitting device, a lighting device, an electronic device, or a manufacturing method thereof.

Note that electronic devices in this specification mean all devices including power storage devices, and electro-optical devices including power storage devices, information terminal devices including power storage devices, and the like are all electronic devices.

### 2. Description of the Related Art

In recent years, a variety of power storage devices such as lithium-ion secondary batteries, lithium-ion capacitors, air batteries, and all-solid-state batteries have been actively developed. In particular, demand for lithium-ion secondary batteries with high output and high capacity has rapidly grown with the development of the semiconductor industry. The lithium-ion secondary batteries are essential as rechargeable energy supply sources for today's information society.

Research and development of a positive electrode and a negative electrode have been variously conducted for improvement of capacity and charge and discharge cycle performance of a lithium-ion secondary battery. It is known that a silicon-based material has higher capacity than a graphite-based material as a negative electrode active material, and thus a negative electrode containing a silicon-based material has been examined (e.g., Patent Document 1 and Patent Document 2).

### REFERENCES

### Patent Documents

[Patent Document 1] Japanese Published Patent Application No. 2010-113870

[Patent Document 2] Japanese Published Patent Application No. 2019-165005

### SUMMARY OF THE INVENTION

There is room for improvements in a variety of aspects of lithium-ion secondary batteries, such as charge and discharge capacity, charge and discharge cycle performance, reliability, safety, and cost.

Therefore, negative electrodes and negative electrode active materials that can improve charge and discharge capacity, charge and discharge cycle performance, reliability, safety, cost, and the like when used in lithium-ion secondary batteries are needed.

An object of one embodiment of the present invention is to provide a negative electrode with excellent charge and discharge capacity and charge and discharge cycle performance that can be used in a lithium-ion secondary battery. Another object is to provide a highly safe or highly reliable secondary battery.

Another object of one embodiment of the present invention is to provide a negative electrode active material, a negative electrode mixed agent, a negative electrode active material layer, and a secondary battery including them, or a formation method thereof.

Note that the description of these objects does not preclude the existence of other objects. In one embodiment of the present invention, there is no need to achieve all these objects. Other objects can be derived from the description of the specification, the drawings, and the claims.

In one embodiment of the present invention, carbon particles and a silicon-based material are mixed and used as a negative electrode active material. As a binder for them, a high molecular compound containing glutamic acid is used. Specifically, a polymer containing glutamic acid is used as the binder.

A lithium-ion secondary battery has a stacked-layer structure in which a positive electrode current collector on which a positive electrode active material layer is formed, a separator, and a negative electrode current collector on which a negative electrode active material layer is formed are stacked. The negative electrode active material layer is formed on one surface or both surfaces of the negative electrode current collector. Slurry is applied over the negative electrode current collector to form the negative electrode active material layer. The slurry is formed in such a manner that carbon particles, silicon particles, and a binder are mixed, and water is added to the mixture. When the carbon particles, the silicon particles, and the binder are mixed at the same time or at once, the process can be shortened.

Graphite, carbon having a layer structure like graphite, amorphous carbon, or hard carbon is used as the carbon particles. Furthermore, carbon fiber may be used instead of the carbon particles. The carbon particles used in this specification specifically refer to graphite particles and they are inexpensive because they abundantly exist in the nature; therefore, they are preferable as an active material of a negative electrode.

In a structure of the invention disclosed in this specification, a secondary battery includes a positive electrode, a negative electrode, a separator between the positive electrode and the negative electrode, and an ionic liquid or an organic solvent between the positive electrode and the negative electrode; and in the secondary battery, the negative electrode includes graphite particles, silicon particles with smaller particle diameters than the graphite particles, and a binder, and the binder contains glutamic acid.

The capacity of silicon is 4200 mAh/g, which is greater than or equal to ten times as large as the capacity of graphite, 372 mAh/g. In the case of a negative electrode using only silicon, there is a problem of drastic cycle deterioration caused by expansion and contraction of particles in charging and discharging. In order to decrease the cycle deterioration, miniaturized silicon particles is preferably used.

In the above structure, the silicon particles refer to silicon powders that are the negative electrode active material of the lithium-ion secondary battery, and an average diameter of the particle size distribution, i.e., an average particle diameter is around 100 nm; the silicon particles are referred to as nanosilicon particles in some cases. In order to obtain silicon particles to be used, it is preferable that a silicon source be ground and particle diameters be adjusted to be uniform. The silicon particles may contain at least one of silicon, silicon oxide, and silicon alloy.

In the above structure, it is preferable that an average particle diameter of the graphite particles mixed with the silicon particles be greater than or equal to 1 μm, preferably greater than or equal to 5 μm and less than or equal to 30 μm. Although laser diffraction particle size distribution measurement can be typically used for measurement of a particle size, the measurement is not limited thereto. A major diameter of a particle cross section may be measured by analysis using a SEM, a transmission electron microscope (TEM), or the like.

In this specification, a negative electrode active material contains both graphite particles and silicon particles. Since silicon particles are mixed and used in a negative electrode, a secondary battery with a high energy density can be achieved.

Note that the weight ratio (wt %) in this specification refers to the compounding ratio at the time of forming electrode slurry described later, i.e., the weight ratio of each of an active material, a conductive additive, and a binder in the total weight (the mixed powder). Therefore, each weight ratio may be different between before and after a secondary battery is formed.

Specifically, the silicon weight ratio in the total weight of the powder materials forming the negative electrode active material is greater than or equal to 7.5 wt % and less than or equal to 37.5 wt %. The negative electrode active material layer has a feature that the weight ratio of silicon particles is less than the weight ratio of graphite particles.

When the negative electrode active material layer is formed, a conductive additive may be added. A typical carbon material used as a conductive additive is acetylene black (also referred to as AB). Acetylene black refers to bulky particles with an average particle diameter of several tens of nanometers to several hundreds of nanometers; thus, the contact between acetylene black and another material hardly becomes surface contact and tends to be point contact. Hence, in the case where an active material and acetylene black are mixed, the contact resistance between the active material and the acetylene black is high. Using a large amount of acetylene black in order to decrease the contact resistance lowers the proportion of the active material in the whole electrode, thereby reducing the discharge capacity of a secondary battery.

In addition, acetylene black is a material that is likely to aggregate, and thus is preferably mixed and uniformly dispersed. The weight ratio of acetylene black is less than or equal to the weight ratio of silicon particles. Needless to say, a secondary battery can be formed without adding the conductive additive (acetylene black).

In the negative electrode of the secondary battery, a binder is mixed in order to fix the current collector such as metal foil and the active material. The binder is also referred to as a binding agent. Since the binder is a high molecular material, a large amount of binder lowers the proportion of the active material in the negative electrode, thereby reducing the discharge capacity of the secondary battery. Therefore, the amount of binder mixed at the time of forming slurry is reduced to a minimum conventionally.

In this specification, a material at least including a high molecular compound containing glutamic acid is preferably used as a binder used in a negative electrode. The high molecular compound containing glutamic acid has hydrophilicity and biodegradability. In a carboxy group included in the high molecular compound containing glutamic acid, oxygen has an unshared electron pair, and there is a possibility that the unshared electron pair helps lithium ions in an electrolyte solution be desolvated and enter the negative electrode active material.

As a binder used in the negative electrode, in particular, a material at least containing a high molecular compound including a carboxy group is preferably used, and polyglutamic acid is particularly preferable. There is a possibility that a polar substituent such as a carboxy group included in a high molecular compound containing glutamic acid helps lithium ions in an electrolyte solution be desolvated and enter the negative electrode active material. Note that the substituent such as a carboxy group can be analyzed by FT-IR or the like. The chemical formula of polyglutamic acid is shown below.

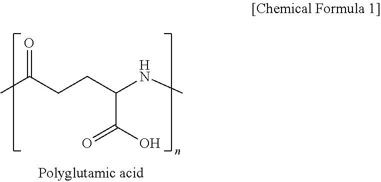

There is no particularly limitation on a method for forming polyglutamic acid. Polyglutamic acid is minute particulate matter and a material in which γ-glutamic acid is the main component. When polyglutamic acid is put into a solvent and the solvent is stirred, the polyglutamic acid can function as a flocculant. Depending on the formation method, polyglutamic acid can be referred to as γ-glutamic acid containing another element (e.g., Ca, Al, Na, Mg, Fe, Si, or S). As long as γ-glutamic acid functions as a flocculant, it may contain another element (e.g., Ca, Al, Na, Mg, Fe, Si, or S). Furthermore, polyglutamic acid may be a crosslinking substance. The weight average molecular weight of polyglutamic acid that is a crosslinking substance can be several tens of millions. Weight average molecular weight is average molecular weight in consideration of weight fraction measured by a viscosity method (in the method, intrinsic viscosity is obtained with a capillary viscometer and calculation is performed with a viscosity formula) or a gel permeation chromatography. Furthermore, in the case where a high molecular compound including a carboxy group is used as a binder in a negative electrode, the weight average molecular weight of the high molecular compound is greater than or equal to eight hundred thousand, preferably fifteen hundred thousand, further preferably twenty-five hundred thousand.

The weight ratio of the binder is preferably less than the weight ratio of graphite particles. When the weight ratio of the binder is too low, the effect becomes small; thus, the weight ratio of the binder to the sum of the graphite particles and the binder is preferably greater than 5 wt %.

Furthermore, a method for forming a negative electrode active material layer is one structure of the present invention. In the structure, a negative electrode active material layer is formed in such a manner that a binder, graphite particles, and silicon particles are mixed to form a mixture, the mixture and a solvent are mixed to prepare slurry, and the slurry is applied over a current collector.

The weight ratios of polyglutamic acid, graphite particles, silicon particles, and acetylene black are adjusted, they are mixed, and then a solvent (e.g., deionized water) is mixed with the mixture; whereby slurry is prepared. A negative electrode active material layer is formed in such a manner that slurry is applied over one or both surfaces of a negative electrode current collector and dried, and pressing is performed; whereby a secondary battery with excellent cycle performance can be provided.

Silicon particles are preferably used in a negative electrode without oxidation. A mixing process of the silicon particles and polyglutamic acid, graphite particles, and acetylene black is preferably performed without oxidation of the silicon particles.

A large amount of binder greatly lowers secondary battery capacity and drastically degrades charge and discharge cycle performance, and thus the amount of binder mixed at the time of forming slurry is reduced to a minimum conventionally. According to one embodiment of the present invention, even when the amount of binder is increased, polyglutamic acid covers nanosilicon, and even when expansion and contraction of nanosilicon is caused, degradation of the negative electrode is inhibited; therefore, a secondary battery can be achieved in which the secondary battery capacity is not greatly lowered and the charge and discharge cycle performance is not drastically degraded.

According to one embodiment of the present invention, a negative electrode with excellent charge and discharge capacity and charge and discharge cycle performance that can be used in a lithium-ion secondary battery can be provided. A highly safe or highly reliable secondary battery can be provided.

One embodiment of the present invention can provide a negative electrode active material, a negative electrode mixed agent, a negative electrode active material layer, and a secondary battery including them, or a formation method thereof.

Note that the description of these effects does not preclude the existence of other effects. One embodiment of the present invention does not necessarily have all these effects. Other effects will be apparent from and can be derived from the description of the specification, the drawings, the claims, and the like.

### BRIEF DESCRIPTION OF THE DRAWINGS

In the accompanying drawings:

FIGS. 1A and 1B are a photograph and a schematic view, respectively, of a top surface of a negative electrode active material layer of one embodiment of the present invention;

FIG. 2 is a cross-sectional photograph of a negative electrode active material layer over a current collector of one embodiment of the present invention;

FIG. 3 shows an example of a formation flow of a negative electrode active material layer of one embodiment of the present invention;

FIG. 4A is an exploded perspective view of a coin-type secondary battery, FIG. 4B is a perspective view of the coin-type secondary battery, and FIG. 4C is a cross-sectional perspective view thereof;

FIG. 5 shows charge and discharge characteristics in Example 1;

FIG. 6 shows cycle performance in Example 2;

FIG. 7A illustrates an example of a cylindrical secondary battery, FIG. 7B illustrates an example of the cylindrical secondary battery, FIG. 7C illustrates an example of a plurality of cylindrical secondary batteries, and FIG. 7D illustrates an example of a power storage system including the plurality of cylindrical secondary batteries;

FIGS. 8A to 8C illustrate an example of a secondary battery;

FIGS. 9A and 9B each illustrate the appearance of a secondary battery;

FIGS. 10A to 10C illustrate a method for forming a secondary battery;

FIGS. 11A to 11D illustrate examples of transport vehicles;

FIGS. 12A and 12B illustrate power storage devices of embodiments of the present invention;

FIG. 13A illustrates an electric bicycle, FIG. 13B illustrates a secondary battery of the electric bicycle, and FIG. 13C illustrates an electric motorcycle;

FIGS. 14A to 14D illustrate examples of electronic devices;

FIG. 15 is a top view photograph of a negative electrode of a comparative example; and

FIG. 16 shows cycle performance of a comparative example.

### DETAILED DESCRIPTION OF THE INVENTION

Hereinafter, embodiments of the present invention will be described in detail with reference to the drawings. Note that the present invention is not limited to the description below, and it is easily understood by those skilled in the art that modes and details of the present invention can be modified in various ways. In addition, the present invention should not be construed as being limited to the description in the following embodiments.

### Embodiment 1

In this embodiment, an example of a negative electrode active material layer and an example of a method for forming a negative electrode including the negative electrode active material layer are described below.

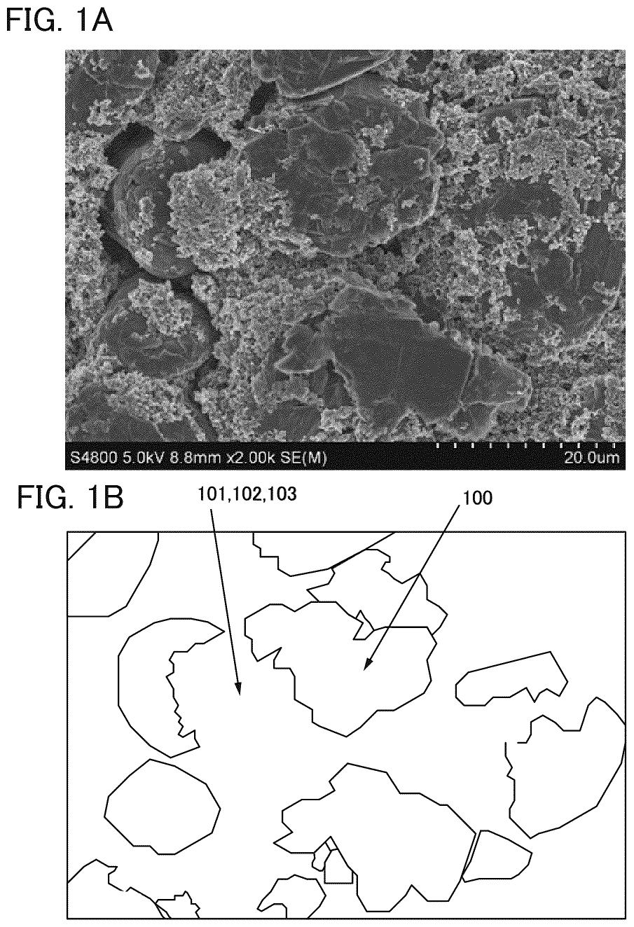

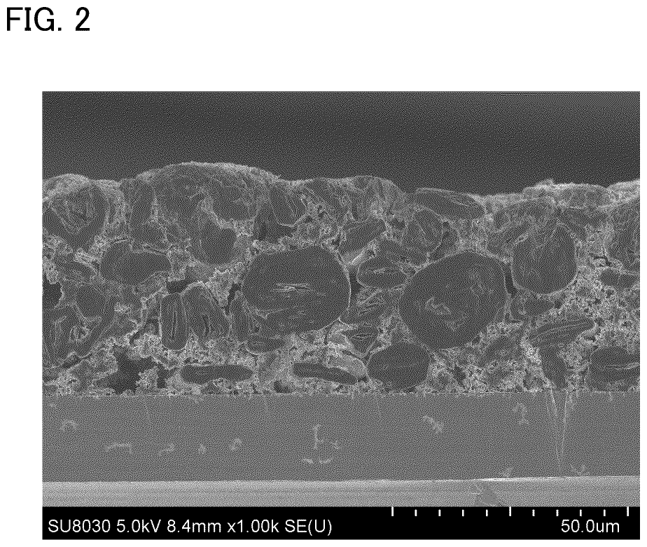

FIG. 1A is a top view photograph of a negative electrode active material layer of this embodiment, and FIG. 1B is a schematic view thereof. Furthermore, FIG. 2 is a cross-sectional photograph of the negative electrode active material layer.

FIG. 1A shows a top view of the negative electrode active material layer in a state where slurry is applied over a negative electrode current collector and then dried. As illustrated in FIG. 1B, part of a surface of a graphite particle 100 is exposed. Furthermore, a binder 102, an aggregate of a silicon particle 101, or an aggregate of AB 103 can be observed between the graphite particles 100.

As the binder 102, a material at least containing a polymer including a carboxy group is preferably used, and polyglutamic acid is used in this embodiment.

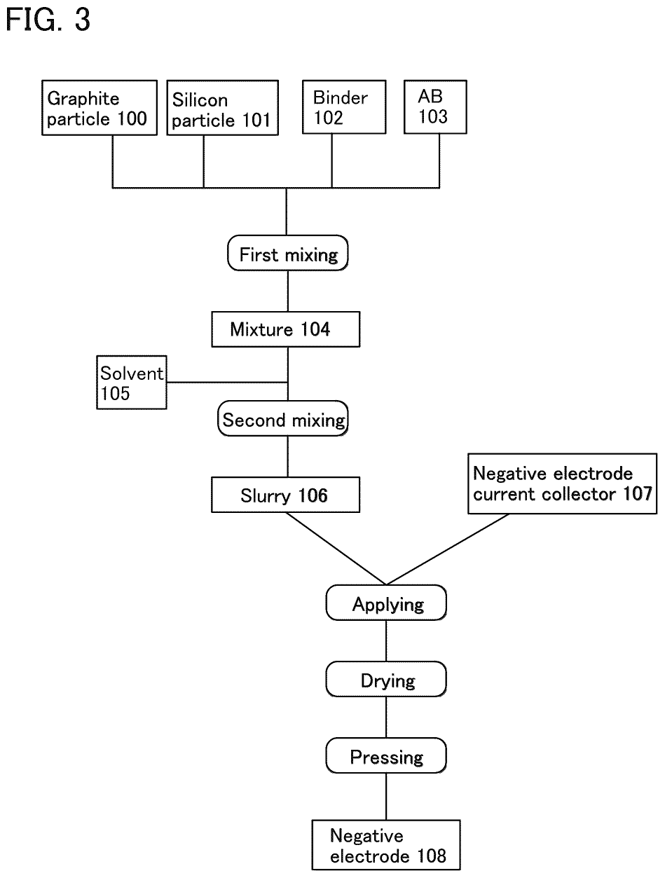

FIG. 3 shows an example of a formation flow of the negative electrode active material layer of this embodiment.

First, the graphite particle 100, the silicon particle 101, the binder 102, and the AB 103 are prepared. Next, each of them are weighed and first mixing is performed. Specifically, the weight ratio of the silicon particle 101 in the total weight of powders mixed in the first mixing is greater than or equal to 7.5 wt % and less than or equal to 37.5 wt %, and the weight ratio of the binder 102 in the total weight is greater than or equal to 10 wt % and less than or equal to 50 wt %. Furthermore, the weight ratio of the AB 103 in the total weight is greater than or equal to 0 wt % and less than or equal to 20 wt %.

For example, the silicon particle 101, the graphite particle 100, the binder 102, and the AB 103 are weighed so that the weight ratio becomes 3:5:1:1. Alternatively, for example, AB is not used and the silicon particle 101, the graphite particle 100, and the binder 102 are weighed so that the weight ratio becomes 3:5:1. The silicon particle 101, the graphite particle 100, and the binder 102 may be weighed so that the weight ratio becomes 1:9:1.

After the first mixing, a solvent 105 is added to a mixture 104 that is a powder and second mixing is performed; whereby, slurry 106 is formed. Deionized water is used as the solvent 105. The second mixing is also referred to as slurry preparation.

The slurry 106 refers to a material solution that is used to form an active material layer over the current collector and includes at least an active material, a binder, and a solvent, with which, if necessary, a conductive additive is also mixed. Slurry may also be referred to as slurry for an electrode or active material slurry; in some cases, slurry for forming a positive electrode active material layer is referred to as slurry for a positive electrode, and slurry for forming a negative electrode active material layer is referred to as slurry for a negative electrode.

Then, the slurry 106 is applied over a negative electrode current collector 107. After that, drying was performed. After the drying, pressing treatment is further performed. Heating may be performed at the same time as the pressing treatment.

Through the above-described steps, a negative electrode 108 in which the negative electrode active material layer is provided over the negative electrode current collector 107 can be formed.

A secondary battery including the negative electrode 108 obtained in the above manner has high discharge capacity and shows excellent cycle performance.

### Embodiment 2

This embodiment describes examples of shapes of a secondary battery including a negative electrode formed by the formation method described in Embodiment 1.

### Coin-Type Secondary Battery

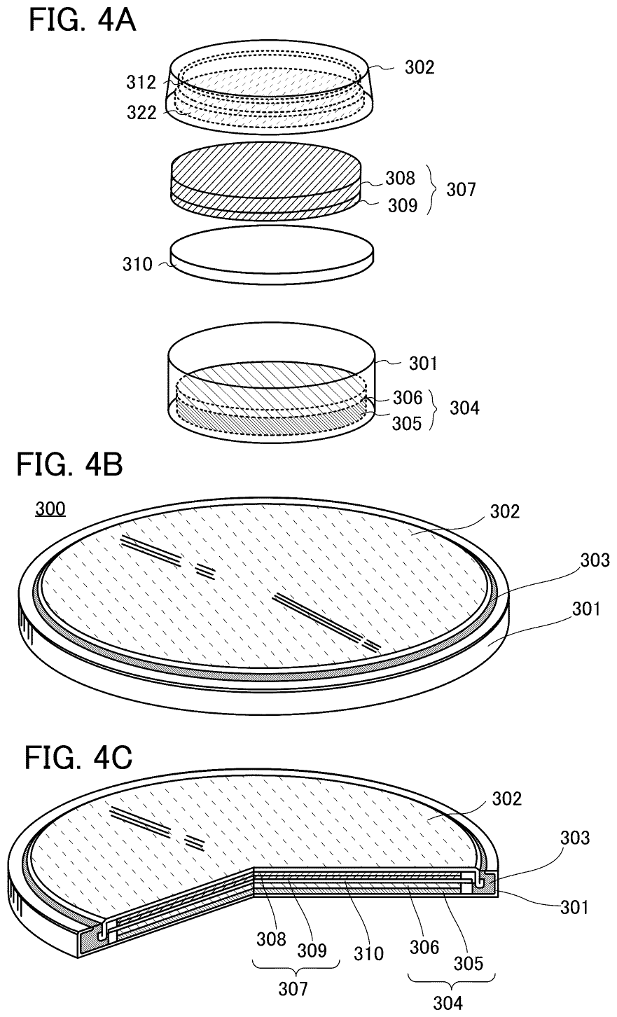

An example of a coin-type secondary battery is described. FIG. 4A, FIG. 4B, and FIG. 4C are an exploded perspective view, an external view, and a cross-sectional view of a coin-type (single-layer flat) secondary battery, respectively. Coin-type secondary batteries are mainly used in small electronic devices.

For easy understanding, FIG. 4A is a schematic view illustrating overlap (a vertical relation and a positional relation) between components. Thus, FIG. 4A and FIG. 4B do not completely correspond with each other.

In FIG. 4A, a positive electrode 304, a separator 310, a negative electrode 307, a spacer 322, and a washer 312 are overlaid. They are sealed with a negative electrode can 302, a positive electrode can 301, and a gasket. Note that the gasket for sealing is not illustrated in FIG. 4A. The spacer 322 and the washer 312 are used to protect the inside or fix the position of the components inside the cans at the time when the positive electrode can 301 and the negative electrode can 302 are bonded with pressure. For the spacer 322 and the washer 312, stainless steel or an insulating material is used.

The positive electrode 304 is a stack in which a positive electrode active material layer 306 is formed over a positive electrode current collector 305.

FIG. 4B is a perspective view of a completed coin-type secondary battery.

In a coin-type secondary battery 300, a positive electrode can 301 doubling as a positive electrode terminal and a negative electrode can 302 doubling as a negative electrode terminal are insulated from each other and sealed by a gasket 303 made of polypropylene. A positive electrode 304 includes a positive electrode current collector 305 and a positive electrode active material layer 306 provided in contact with the positive electrode current collector 305. A negative electrode 307 includes a negative electrode current collector 308 and a negative electrode active material layer 309 provided in contact with the negative electrode current collector 308. The negative electrode 307 is not limited to having a stacked-layer structure, and lithium metal foil or lithium metal-aluminum alloy foil may be used.

Note that only one surface of each of the positive electrode 304 and the negative electrode 307 used for the coin-type secondary battery 300 is provided with an active material layer.

For the positive electrode can 301 and the negative electrode can 302, a metal having corrosion resistance to an electrolyte solution, such as nickel, aluminum, or titanium, an alloy of such a metal, or an alloy of such a metal and another metal (e.g., stainless steel) can be used. The positive electrode can 301 and the negative electrode can 302 are preferably covered with nickel or aluminum in order to prevent corrosion due to the electrolyte solution. The positive electrode can 301 and the negative electrode can 302 are electrically connected to the positive electrode 304 and the negative electrode 307, respectively.

The negative electrode 307, the positive electrode 304, and the separator 310 are immersed in the electrolyte solution or an ionic liquid. Then, as illustrated in FIG. 4C, the positive electrode 304, the separator 310, the negative electrode 307, and the negative electrode can 302 are stacked in this order with the positive electrode can 301 positioned at the bottom, and the positive electrode can 301 and the negative electrode can 302 are bonded with pressure with the gasket 303 therebetween. In this manner, the coin-type secondary battery 300 is formed.

The separator 310 can be formed using, for example, a fiber containing cellulose, such as paper, nonwoven fabric, glass fiber, ceramics, or synthetic fiber containing a nylon resin (polyamide), a vinylon resin (polyvinyl alcohol-based fiber), a polyester resin, an acrylic resin, a polyolefin resin, or a polyurethane resin.

The separator may have a multilayer structure. For example, an organic material film of polypropylene, polyethylene, or the like can be coated with a ceramics-based material, a fluorine-based material, a polyamide-based material, a mixture thereof, or the like. Examples of the ceramics-based material include aluminum oxide particles and silicon oxide particles. Examples of the fluorine-based material include PVDF and polytetrafluoroethylene. Examples of the polyamide-based material include nylon and aramid (meta-based aramid and para-based aramid).

When the separator is coated with the ceramics-based material, the oxidation resistance is improved; hence, deterioration of the separator in high-voltage charging and discharging can be inhibited and thus the reliability of the secondary battery can be improved. When the separator is coated with the fluorine-based material, the separator is easily brought into close contact with an electrode, resulting in high output characteristics. When the separator is coated with the polyamide-based material, in particular, aramid, the safety of the secondary battery is improved because heat resistance is improved.

For example, both surfaces of a polypropylene film may be coated with a mixed material of aluminum oxide and aramid. Alternatively, a surface of a polypropylene film that is in contact with the positive electrode may be coated with a mixed material of aluminum oxide and aramid, and a surface of the polypropylene film that is in contact with the negative electrode may be coated with the fluorine-based material.

With the use of a separator having a multilayer structure, the capacity per volume of the secondary battery can be increased because the safety of the secondary battery can be maintained even when the total thickness of the separator is small.

With the above structure, the coin-type secondary battery 300 can have excellent cycle performance. This embodiment can be combined with Embodiment 1.

### Embodiment 3

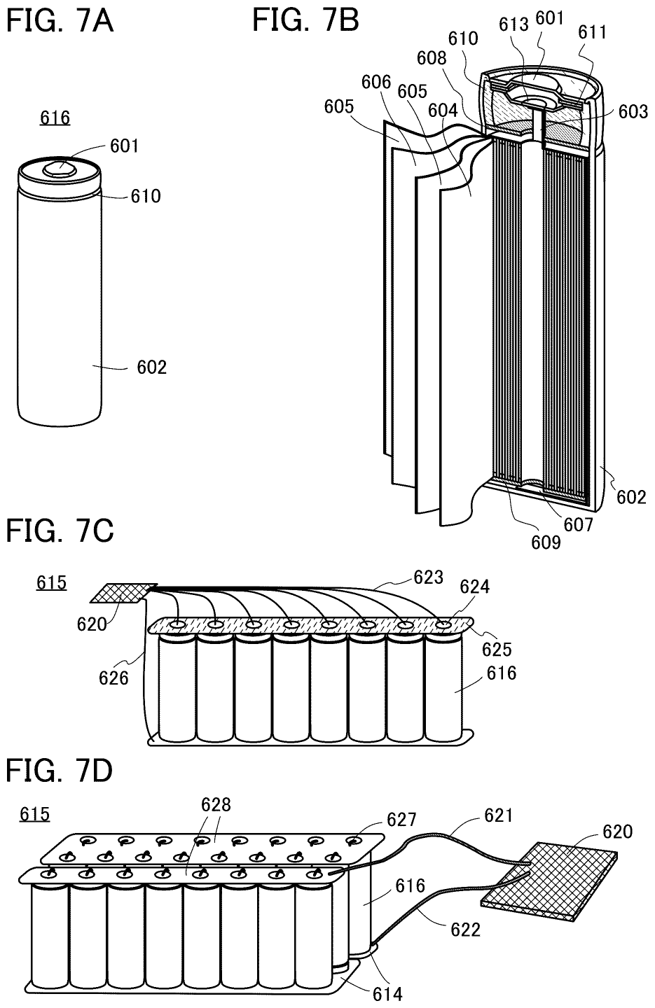

An example of a cylindrical secondary battery is described with reference to FIG. 7A. As illustrated in FIG. 7A, a cylindrical secondary battery 616 includes a positive electrode cap (battery cap) 601 on the top surface and a battery can (outer can) 602 on the side surface and bottom surface. The positive electrode cap 601 and the battery can (outer can) 602 are insulated from each other by a gasket (insulating gasket) 610.

FIG. 7B is a schematic view of a cross-section of the cylindrical secondary battery. The cylindrical secondary battery illustrated in FIG. 7B includes the positive electrode cap (battery cap) 601 on the top surface and the battery can (outer can) 602 on the side surface and bottom surface. The positive electrode cap 601 and the battery can (outer can) 602 are insulated from each other by the gasket (insulating gasket) 610.

Inside the battery can 602 having a hollow cylindrical shape, a wound body in which a strip-like positive electrode 604 and a strip-like negative electrode 606 are wound with a strip-like separator 605 located therebetween is provided. Although not illustrated, the wound body is wound around the central axis. One end of the battery can 602 is close and the other end thereof is open. For the battery can 602, a metal having corrosion resistance to an electrolyte solution, such as nickel, aluminum, or titanium, an alloy of such a metal, or an alloy of such a metal and another metal (e.g., stainless steel) can be used. The battery can 602 is preferably covered with nickel and aluminum in order to prevent corrosion due to the electrolyte solution. Inside the battery can 602, the wound body in which the positive electrode, the negative electrode, and the separator are wound is provided between a pair of insulating plates 608 and 609 that face each other. Furthermore, the inside of the battery can 602 provided with the wound body is filled with a nonaqueous electrolyte solution (not illustrated). As the nonaqueous electrolyte solution, an electrolyte solution similar to that for the coin-type secondary battery can be used.

Since the positive electrode and the negative electrode of the cylindrical storage battery are wound, active materials are preferably formed on both sides of the current collectors.

The negative electrode active material layer obtained in Embodiment 1 is used in the negative electrode 606, whereby the cylindrical secondary battery 616 can have high capacity and excellent cycle performance.

A positive electrode terminal (positive electrode current collecting lead) 603 is connected to the positive electrode 604, and a negative electrode terminal (negative electrode current collecting lead) 607 is connected to the negative electrode 606. Both the positive electrode terminal 603 and the negative electrode terminal 607 can be formed using a metal material such as aluminum. The positive electrode terminal 603 and the negative electrode terminal 607 are resistance-welded to a safety valve mechanism 613 and the bottom of the battery can 602, respectively. The safety valve mechanism 613 is electrically connected to the positive electrode cap 601 through a positive temperature coefficient (PTC) element 611. The safety valve mechanism 613 cuts off electrical connection between the positive electrode cap 601 and the positive electrode 604 when the internal pressure of the battery exceeds a predetermined threshold value. The PTC element 611, which is a thermally sensitive resistor whose resistance increases as temperature rises, limits the amount of current by increasing the resistance, in order to prevent abnormal heat generation. Barium titanate (BaTiO₃)-based semiconductor ceramics can be used for the PTC element.

FIG. 7C illustrates an example of a power storage system 615. The power storage system 615 includes a plurality of secondary batteries 616. The positive electrodes of the secondary batteries are in contact with and electrically connected to conductors 624 isolated by an insulator 625. The conductor 624 is electrically connected to a control circuit 620 through a wiring 623. The negative electrodes of the secondary batteries are electrically connected to the control circuit 620 through a wiring 626. As the control circuit 620, a charge and discharge control circuit or a protection circuit for preventing overcharge and/or overdischarge can be used.

FIG. 7D illustrates an example of the power storage system 615. The power storage system 615 includes a plurality of secondary batteries 616, and the plurality of secondary batteries 616 are sandwiched between a conductive plate 628 and a conductive plate 614. The plurality of secondary batteries 616 are electrically connected to the conductive plate 628 and the conductive plate 614 through a wiring 627. The plurality of secondary batteries 616 may be connected in parallel, connected in series, or connected in parallel and then those sets may be connected in series. With the power storage system 615 including the plurality of secondary batteries 616, large electric power can be extracted.

The plurality of secondary batteries 616 may be connected in series after being connected in parallel.

A temperature control device may be provided between the plurality of secondary batteries 616. The secondary batteries 616 can be cooled with the temperature control device when overheated, whereas the secondary batteries 616 can be heated with the temperature control device when cooled too much. Thus, the performance of the power storage system 615 is less likely to be influenced by the outside temperature.

In FIG. 7D, the power storage system 615 is electrically connected to the control circuit 620 through a wiring 621 and a wiring 622. The wiring 621 is electrically connected to the positive electrodes of the plurality of secondary batteries 616 through the conductive plate 628. The wiring 622 is electrically connected to the negative electrodes of the plurality of secondary batteries 616 through the conductive plate 614.

### Other Structure Examples of Secondary Battery

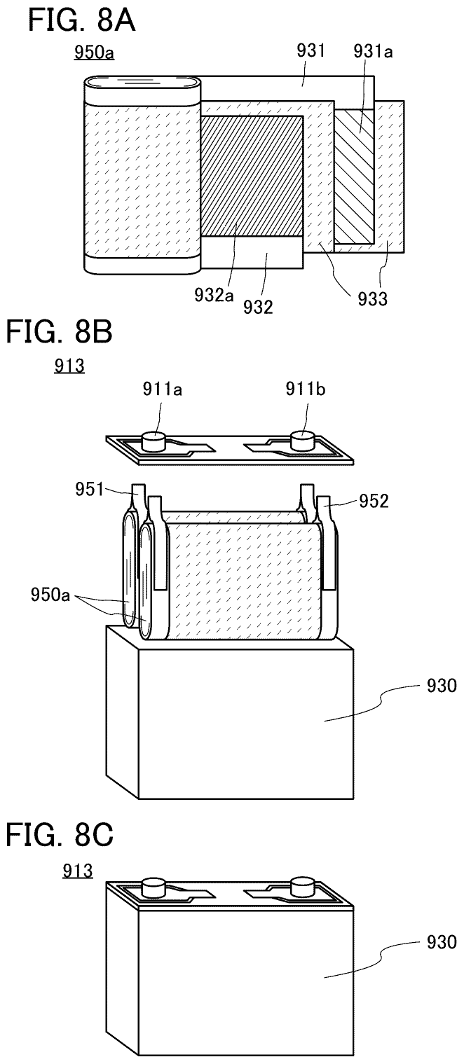

Structure examples of secondary batteries are described with reference to FIGS. 8A to 8C.

As illustrated in FIG. 8A, the secondary battery 913 may include a wound body 950a. The wound body 950a illustrated in FIG. 8A includes a negative electrode 931, a positive electrode 932, and separators 933. The negative electrode 931 includes a negative electrode active material layer 931a. The positive electrode 932 includes a positive electrode active material layer 932a.

The separator 933 has a larger width than the negative electrode active material layer 931a and the positive electrode active material layer 932a, and is wound to overlap the negative electrode active material layer 931a and the positive electrode active material layer 932a. In terms of safety, the width of the negative electrode active material layer 931a is preferably larger than that of the positive electrode active material layer 932a. The wound body 950a having such a shape is preferable because of its high degree of safety and high productivity.

The negative electrode active material layer obtained in Embodiment 1 is used in the negative electrode 931, whereby the secondary battery 913 can have high capacity and excellent cycle performance.

As illustrated in FIG. 8B, the negative electrode 931 is electrically connected to the terminal 951 by ultrasonic bonding, welding, or pressure bonding. The terminal 951 is electrically connected to a terminal 911a. The positive electrode 932 is electrically connected to the terminal 952 by ultrasonic bonding, welding, or pressure bonding. The terminal 952 is electrically connected to a terminal 911b.

As illustrated in FIG. 8C, the wound body 950a and an electrolyte solution are covered with a housing 930, whereby the secondary battery 913 is completed. The housing 930 is preferably provided with a safety valve and an overcurrent protection element. For the housing 930, a metal material (e.g., aluminum) or a resin material can be used. A safety valve is a valve to be released by a predetermined internal pressure of the housing 930 in order to prevent the battery from exploding.

As illustrated in FIG. 8B, the secondary battery 913 may include a plurality of wound bodies 950a. The use of the plurality of wound bodies 950a enables the secondary battery 913 to have higher discharge capacity.

### Laminated Secondary Battery

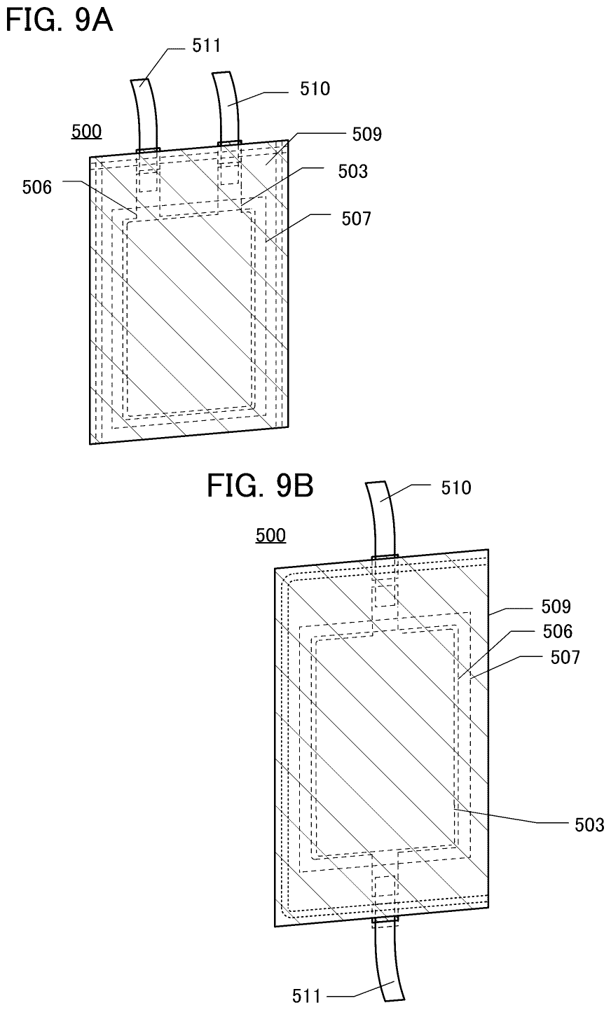

Next, examples of the appearance of a laminated secondary battery are illustrated in FIGS. 9A and 9B. FIGS. 9A and 9B each illustrate a positive electrode 503, a negative electrode 506, a separator 507, an exterior body 509, a positive electrode lead electrode 510, and a negative electrode lead electrode 511.

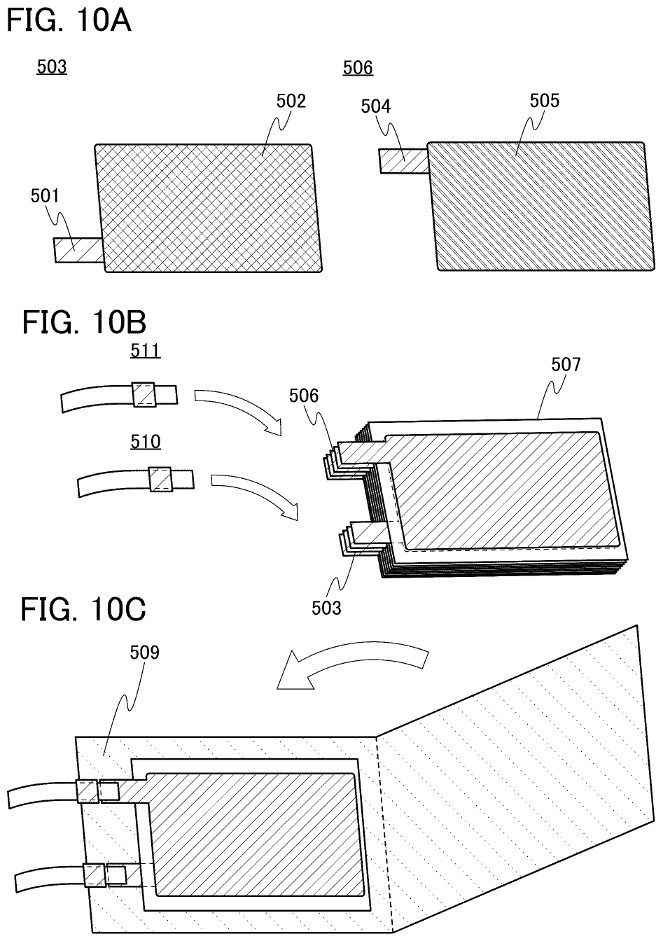

FIG. 10A illustrates external views of the positive electrode 503 and the negative electrode 506. The positive electrode 503 includes a positive electrode current collector 501, and a positive electrode active material layer 502 is formed on a surface of the positive electrode current collector 501. The positive electrode 503 also includes a region where the positive electrode current collector 501 is partly exposed (hereinafter referred to as a tab region). The negative electrode 506 includes a negative electrode current collector 504, and a negative electrode active material layer 505 is formed on a surface of the negative electrode current collector 504. The negative electrode 506 also includes a region where the negative electrode current collector 504 is partly exposed, that is, a tab region. The areas or the shapes of the tab regions included in the positive electrode and the negative electrode are not limited to those in the example illustrated in FIG. 10A.

### Method for Forming Laminated Secondary Battery

An example of a method for forming the laminated secondary battery having the appearance illustrated in FIG. 9A will be described with reference to FIGS. 10B and 10C.

First, the negative electrode 506, the separator 507, and the positive electrode 503 are stacked. FIG. 10B illustrates a stack including the negative electrode 506, the separator 507, and the positive electrode 503. The secondary battery in this example includes five negative electrodes and four positive electrodes. The component at this stage can also be referred to as a stack including the negative electrodes, the separators, and the positive electrodes. Next, the tab regions of the positive electrodes 503 are bonded to each other, and the positive electrode lead electrode 510 is bonded to the tab region of the positive electrode on the outermost surface. The bonding can be performed by ultrasonic welding, for example. In a similar manner, the tab regions of the negative electrodes 506 are bonded to each other, and the negative electrode lead electrode 511 is bonded to the tab region of the negative electrode on the outermost surface.

Then, the negative electrodes 506, the separators 507, and the positive electrodes 503 are placed over the exterior body 509.

Subsequently, the exterior body 509 is folded along a dashed line as illustrated in FIG. 10C. Then, the outer edges of the exterior body 509 are bonded to each other. The bonding can be performed by thermocompression, for example. At this time, a part (or one side) of the exterior body 509 is left unbonded (to provide an inlet) so that the electrolyte solution can be introduced later.

Next, the electrolyte solution is introduced into the exterior body 509 from the inlet of the exterior body 509. The electrolyte solution is preferably introduced in a reduced pressure atmosphere or in an inert atmosphere. Lastly, the inlet is sealed by bonding. In this manner, the laminated secondary battery 500 can be formed.

The negative electrode active material layer obtained in Embodiment 1 is used in the negative electrodes 506, whereby the secondary battery 500 can have excellent cycle performance. This embodiment can be freely combined with Embodiment 2.

### Embodiment 4

Next, examples in which a secondary battery including the negative electrode of one embodiment of the present invention is mounted on a vehicle, typically a transport vehicle, will be described.

Mounting a plurality of secondary batteries illustrated in any of FIG. 7A, FIG. 8C, FIG. 9A, and FIG. 9B on vehicles can achieve next-generation clean energy vehicles such as hybrid vehicles (HVs), electric vehicles (EVs), and plug-in hybrid vehicles (PHVs). The secondary battery can also be mounted on transport vehicles such as agricultural machines, motorized bicycles including motor-assisted bicycles, motorcycles, electric wheelchairs, electric carts, boats and ships, submarines, aircraft such as fixed-wing aircraft and rotary-wing aircraft, rockets, artificial satellites, space probes, planetary probes, and spacecraft. The secondary battery of one embodiment of the present invention can be highly safe. Thus, the secondary battery of one embodiment of the present invention has a long lifetime and is suitably used in transport vehicles.

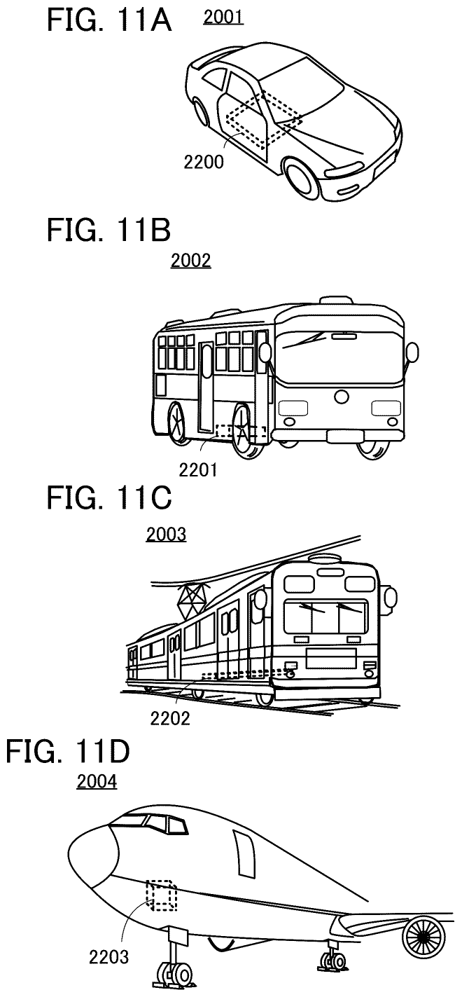

FIGS. 11A to 11D illustrate examples of transport vehicles using one embodiment of the present invention. An automobile 2001 illustrated in FIG. 11A is an electric vehicle that runs on the power of an electric motor. Alternatively, the automobile 2001 is a hybrid electric vehicle capable of driving using either an electric motor or an engine as appropriate. In the case where the secondary battery is mounted on the vehicle, the secondary battery exemplified in Embodiment 3 is provided at one position or several positions. The automobile 2001 illustrated in FIG. 11A includes a battery pack 2200, and the battery pack includes a secondary battery module in which a plurality of secondary batteries are connected to each other. Moreover, the battery pack preferably includes a charge control device that is electrically connected to the secondary battery module.

The automobile 2001 can be charged when the secondary battery included in the automobile 2001 is supplied with electric power through external charging equipment by a plug-in system, a contactless power feeding system, or the like. In charging, a given method such as CHAdeMO (registered trademark) or Combined Charging System can be employed as a charging method, the standard of a connector, or the like as appropriate. Charging equipment may be a charging station provided in a commerce facility or a power source in a house. For example, with the use of the plug-in technique, the power storage device mounted on the automobile 2001 can be charged by being supplied with electric power from outside. The charge can be performed by converting AC electric power into DC electric power through a converter such as an AC-DC converter.

Although not illustrated, the vehicle may include a power receiving device so that it can be charged by being supplied with electric power from an above-ground power transmitting device in a contactless manner. In the case of the contactless power feeding system, by fitting a power transmitting device in a road or an exterior wall, charge can be performed not only when the vehicle is stopped but also when driven. In addition, the contactless power feeding system may be utilized to perform transmission and reception of electric power between two vehicles. Furthermore, a solar cell may be provided in the exterior of the vehicle to charge the secondary battery when the vehicle stops and moves. To supply electric power in such a contactless manner, an electromagnetic induction method or a magnetic resonance method can be used.

FIG. 11B illustrates a large transporter 2002 having a motor controlled by electricity as an example of a transport vehicle. A secondary battery module of the transporter 2002 includes a cell unit of four secondary batteries with a nominal voltage of 3.0 V or higher and 5.0 V or lower, for example, and 48 cells are connected in series to have a maximum voltage of 170 V. A battery pack 2201 has the same function as that in FIG. 11A except the number of secondary batteries configuring the secondary battery module; thus, the description is omitted.

FIG. 11C illustrates a large transportation vehicle 2003 having a motor controlled by electricity as an example. A secondary battery module of the transportation vehicle 2003 has 100 or more secondary batteries with a nominal voltage of 3.0 V or higher and 5.0 V or lower connected in series, and the maximum voltage is 600 V. With the use of the negative electrode using the negative electrode active material described in Embodiment 1, a secondary battery having favorable rate characteristics and charge and discharge cycle performance can be formed, which can contribute to higher performance and a longer life of the transport vehicle 2003. A battery pack 2202 has the same function as that in FIG. 11A except the number of secondary batteries configuring the secondary battery module; thus, the description is omitted.

FIG. 11D illustrates an aircraft 2004 having a combustion engine as an example. The aircraft 2004 illustrated in FIG. 11D is regarded as a transport vehicle because it has wheels for takeoff and landing, and includes a battery pack 2203 that includes a charge control device and a secondary battery module configured by connecting a plurality of secondary batteries.

The secondary battery module of the aircraft 2004 has eight 4 V secondary batteries connected in series, which has the maximum voltage of 32 V, for example. The battery pack 2203 has the same function as that in FIG. 11A except, for example, the number of secondary batteries configuring the secondary battery module; thus, the description is omitted.

The contents in this embodiment can be combined with any of the contents in the other embodiments as appropriate.

### Embodiment 5

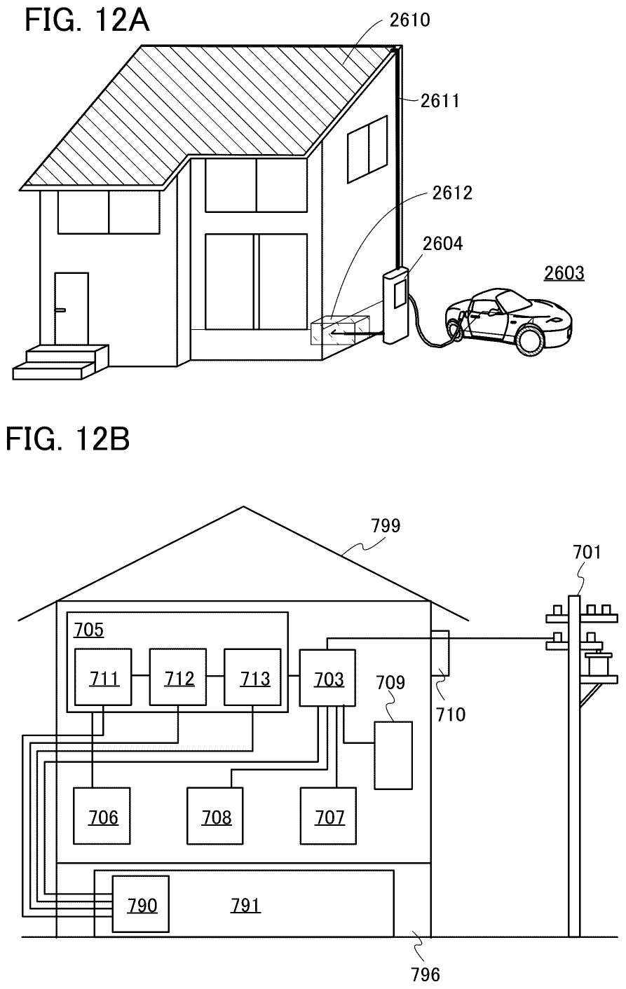

In this embodiment, examples in which the secondary battery of one embodiment of the present invention is mounted on a building will be described with reference to FIGS. 12A and 12B.

A house illustrated in FIG. 12A includes a power storage device 2612 including the secondary battery of one embodiment of the present invention and a solar panel 2610. The power storage device 2612 is electrically connected to the solar panel 2610 through a wiring 2611 or the like. The power storage device 2612 may be electrically connected to a ground-based charging device 2604. The power storage device 2612 can be charged with electric power generated by the solar panel 2610. A secondary battery included in a vehicle 2603 can be charged with the electric power stored in the power storage device 2612 through the charging device 2604. The power storage device 2612 is preferably provided in an underfloor space. The power storage device 2612 is preferably provided in the underfloor space, in which case the space on the floor can be effectively used. Alternatively, the power storage device 2612 may be provided on the floor.

The electric power stored in the power storage device 2612 can also be supplied to other electronic devices in the house. Thus, the electronic devices can be operated in indoor environments with the use of the power storage device 2612 of one embodiment of the present invention as an uninterruptible power source even when electric power cannot be supplied from the commercial power supply due to power failure.

FIG. 12B illustrates an example of a power storage device of one embodiment of the present invention. As illustrated in FIG. 12B, a power storage device 791 of one embodiment of the present invention is provided in an underfloor space 796 of a building 799. When a secondary battery including the negative electrode active material layer described in Embodiment 1 in a negative electrode is used in the power storage device 791, the power storage device 791 can have high discharge capacity.

The power storage device 791 is provided with a control device 790, and the control device 790 is electrically connected to a distribution board 703, a power storage controller (also referred to as control device) 705, an indicator 706, and a router 709 through wirings.

Electric power is transmitted from a commercial power source 701 to the distribution board 703 through a service wire mounting portion 710. Moreover, electric power is transmitted to the distribution board 703 from the power storage device 791 and the commercial power source 701, and the distribution board 703 supplies the transmitted electric power to a general load 707 and a power storage load 708 through outlets (not illustrated).

The general load 707 is, for example, an electrical device such as a TV or a personal computer. The power storage load 708 is, for example, an electrical device such as a microwave, a refrigerator, or an air conditioner.

The power storage controller 705 includes a measuring portion 711, a predicting portion 712, and a planning portion 713. The measuring portion 711 has a function of measuring the amount of electric power consumed by the general load 707 and the power storage load 708 during a day (e.g., from midnight to midnight). The measuring portion 711 may also have a function of measuring the amount of electric power of the power storage device 791 and the amount of electric power supplied from the commercial power source 701. The predicting portion 712 has a function of predicting, on the basis of the amount of electric power consumed by the general load 707 and the power storage load 708 during a given day, the demand for electric power consumed by the general load 707 and the power storage load 708 during the next day. The planning portion 713 has a function of making a charge and discharge plan of the power storage device 791 on the basis of the demand for electric power predicted by the predicting portion 712.

The indicator 706 can show the amount of electric power consumed by the general load 707 and the power storage load 708 that is measured by the measuring portion 711. An electrical device such as a TV or a personal computer can also show it through the router 709. Furthermore, a portable electronic terminal such as a smartphone or a tablet can also show it through the router 709. The indicator 706, the electrical device, and the portable electronic terminal can also show, for example, the demand for electric power depending on a time period (or per hour) that is predicted by the predicting portion 712.

The contents in this embodiment can be combined with any of the contents in the other embodiments as appropriate.

### Embodiment 6

This embodiment will describe examples in which the power storage device of one embodiment of the present invention is mounted on a motorcycle and a bicycle.

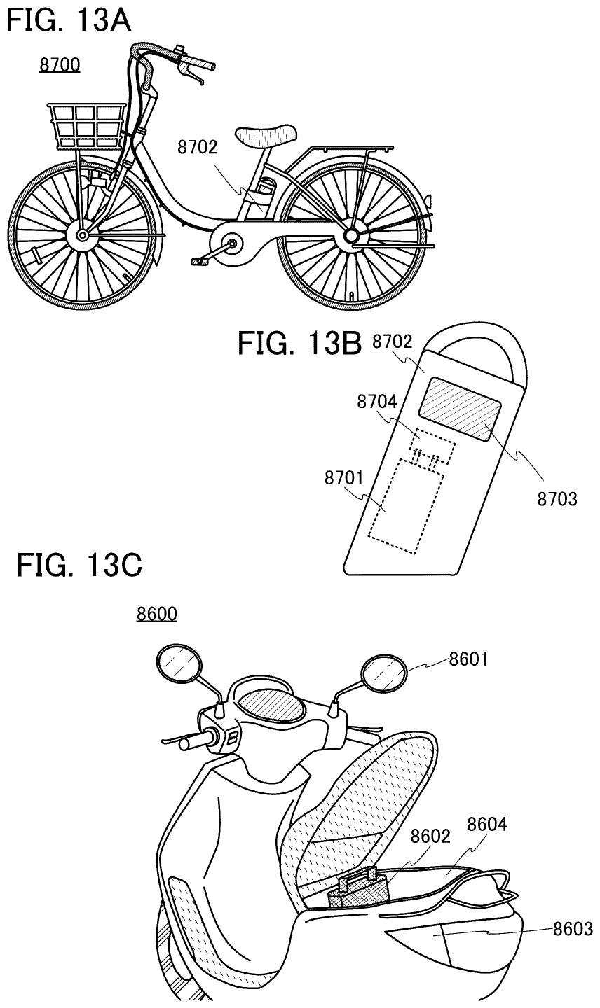

FIG. 13A illustrates an example of an electric bicycle using the power storage device of one embodiment of the present invention. The power storage device of one embodiment of the present invention can be used for an electric bicycle 8700 in FIG. 13A. The power storage device of one embodiment of the present invention includes a plurality of storage batteries and a protection circuit, for example.

The electric bicycle 8700 is provided with a power storage device 8702. The power storage device 8702 can supply electric power to a motor that assists a rider. The power storage device 8702 is portable, and FIG. 13B illustrates the state where the power storage device 8702 is removed from the electric bicycle. The power storage device 8702 incorporates a plurality of storage batteries 8701 included in the power storage device of one embodiment of the present invention, and can display the remaining battery level on a display portion 8703. The power storage device 8702 includes a control circuit 8704 capable of charge control or anomaly detection for a secondary battery. The control circuit 8704 is electrically connected to a positive electrode and a negative electrode of the storage battery 8701. The control circuit 8704 may be provided with a small solid-state secondary battery. When the small solid-state secondary battery is provided in the control circuit 8704, electric power can be supplied to store data in a memory circuit included in the control circuit 8704 for a long time.

FIG. 13C illustrates an example of a motorcycle using the power storage device of one embodiment of the present invention. A motor scooter 8600 illustrated in FIG. 13C includes a power storage device 8602, side mirrors 8601, and indicators 8603. The power storage device 8602 can supply electric power to the indicators 8603. The power storage device 8602 including a plurality of secondary batteries having the negative electrode described in Embodiment 1 can have high capacity and contribute to a reduction in size.

In the motor scooter 8600 illustrated in FIG. 13C, the power storage device 8602 can be held in an under-seat storage unit 8604. The power storage device 8602 can be held in the under-seat storage unit 8604 even with a small size.

The contents in this embodiment can be combined with any of the contents in the other embodiments as appropriate.

### Embodiment 7

In this embodiment, examples of electronic devices each including the secondary battery of one embodiment of the present invention are described. Examples of the electronic device including the secondary battery include a television device (also referred to as a television or a television receiver), a monitor of a computer and the like, a digital camera, a digital video camera, a digital photo frame, a mobile phone (also referred to as a cellular phone or a mobile phone device), a portable game console, a portable information terminal, an audio reproducing device, and a large-sized game machine such as a pachinko machine. Examples of the portable information terminal include a laptop personal computer, a tablet terminal, an e-book reader, and a mobile phone.

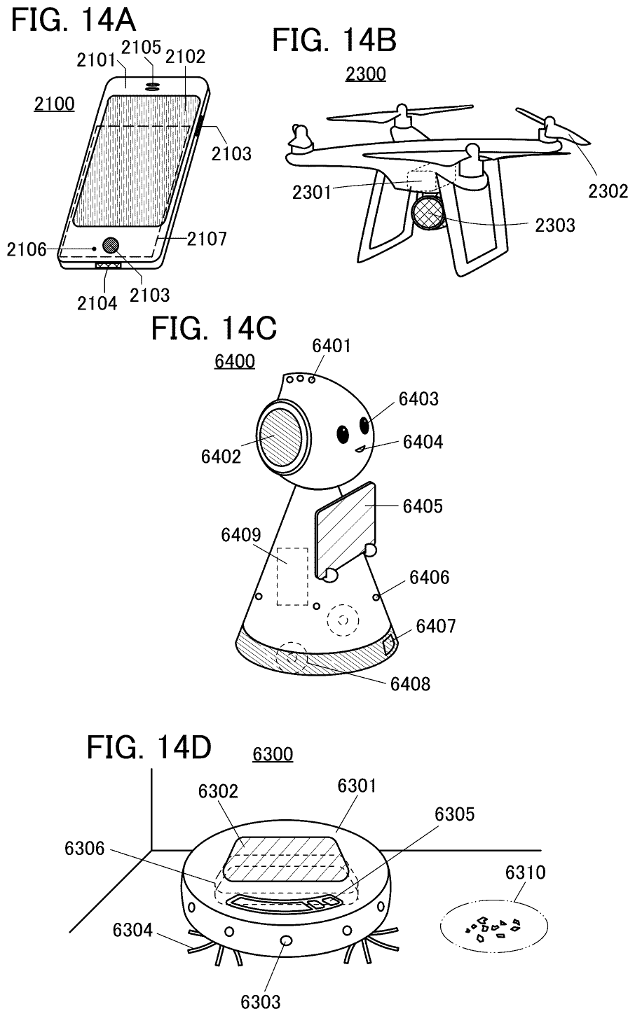

FIG. 14A illustrates an example of a mobile phone. A mobile phone 2100 includes a housing 2101 in which a display portion 2102 is incorporated, an operation button 2103, an external connection port 2104, a speaker 2105, a microphone 2106, and the like. The mobile phone 2100 includes a secondary battery 2107. The use of the secondary battery 2107 including the negative electrode described in Embodiment 1 achieves high capacity and a structure that accommodates space saving due to a reduction in size of the housing.

The mobile phone 2100 is capable of executing a variety of applications such as mobile phone calls, e-mailing, viewing and editing texts, music reproduction, Internet communication, and a computer game.

With the operation button 2103, a variety of functions such as time setting, power on/off, on/off of wireless communication, setting and cancellation of a silent mode, and setting and cancellation of a power saving mode can be performed. For example, the functions of the operation button 2103 can be set freely by the operating system incorporated in the mobile phone 2100.

The mobile phone 2100 can employ near field communication based on an existing communication standard. For example, mutual communication between the mobile phone 2100 and a headset capable of wireless communication can be performed, and thus hands-free calling is possible.

Moreover, the mobile phone 2100 includes the external connection port 2104, and data can be directly transmitted to and received from another information terminal via a connector. In addition, charge can be performed via the external connection port 2104. Note that the charge operation may be performed by wireless power feeding without using the external connection port 2104.

The mobile phone 2100 preferably includes a sensor. As the sensor, a human body sensor such as a fingerprint sensor, a pulse sensor, or a temperature sensor, a touch sensor, a pressure sensitive sensor, or an acceleration sensor is preferably mounted, for example.

FIG. 14B illustrates an unmanned aircraft 2300 including a plurality of rotors 2302. The unmanned aircraft 2300 is also referred to as a drone. The unmanned aircraft 2300 includes a secondary battery 2301 of one embodiment of the present invention, a camera 2303, and an antenna (not illustrated). The unmanned aircraft 2300 can be remotely controlled through the antenna. A secondary battery including the negative electrode described in Embodiment 1 has high cycle performance and a high degree of safety, and thus can be used safely for a long time over a long period of time and is preferable as the secondary battery included in the unmanned aircraft 2300.

FIG. 14C illustrates an example of a robot. A robot 6400 illustrated in FIG. 14C includes a secondary battery 6409, an illuminance sensor 6401, a microphone 6402, an upper camera 6403, a speaker 6404, a display portion 6405, a lower camera 6406, an obstacle sensor 6407, a moving mechanism 6408, an arithmetic device, and the like.

The microphone 6402 has a function of detecting a speaking voice of a user, an environmental sound, and the like. The speaker 6404 has a function of outputting sound. The robot 6400 can communicate with a user using the microphone 6402 and the speaker 6404.

The display portion 6405 has a function of displaying various kinds of information. The robot 6400 can display information desired by the user on the display portion 6405. The display portion 6405 may be provided with a touch panel. Moreover, the display portion 6405 may be a detachable information terminal, in which case charge and data communication can be performed when the display portion 6405 is set at the home position of the robot 6400.

The upper camera 6403 and the lower camera 6406 each have a function of taking an image of the surroundings of the robot 6400. The obstacle sensor 6407 can detect an obstacle in the direction where the robot 6400 advances with the moving mechanism 6408. The robot 6400 can move safely by recognizing the surroundings with the upper camera 6403, the lower camera 6406, and the obstacle sensor 6407.

The robot 6400 further includes, in its inner region, the secondary battery 6409 of one embodiment of the present invention and a semiconductor device or an electronic component. A secondary battery including the negative electrode described in Embodiment 1 has high cycle performance and a high degree of safety, and thus can be used safely for a long time over a long period of time and is preferable as the secondary battery 6409 included in the robot 6400.

FIG. 14D illustrates an example of a cleaning robot. A cleaning robot 6300 includes a display portion 6302 placed on the top surface of a housing 6301, a plurality of cameras 6303 placed on the side surface of the housing 6301, a brush 6304, operation buttons 6305, a secondary battery 6306, a variety of sensors, and the like. Although not illustrated, the cleaning robot 6300 is provided with a tire, an inlet, and the like. The cleaning robot 6300 is self-propelled, detects dust 6310, and sucks up the dust through the inlet provided on the bottom surface.

For example, the cleaning robot 6300 can determine whether there is an obstacle such as a wall, furniture, or a step by analyzing images taken by the cameras 6303. In the case where the cleaning robot 6300 detects an object that is likely to be caught in the brush 6304 (e.g., a wire) by image analysis, the rotation of the brush 6304 can be stopped. The cleaning robot 6300 further includes, in its inner region, the secondary battery 6306 of one embodiment of the present invention and a semiconductor device or an electronic component. A secondary battery including the negative electrode described in Embodiment 1 has a high energy density and a high degree of safety, and thus can be used safely for a long time over a long period of time and is preferable as the secondary battery 6306 included in the cleaning robot 6300.

The contents in this embodiment can be combined with the contents in any of the other embodiments as appropriate.

### Example 1

In this example, a half cell was formed using polyglutamic acid as a binder, and the cycle performance was measured.

First, silicon particles, graphite particles, and a binder were prepared and weighed.

As the silicon particles in this example, silicon particles (product number 633097 manufactured by Sigma-Aldrich Co. LLC) each of which has a specific surface area of 12.7715 m²/g by a BET method and a particle diameter of 100 nm were used.

The specific surface areas of silicon particles by a BET method are values measured by a nitrogen gas adsorption one-point BET method, and a surface area and porosity analyzer Tri Star II 3020 (manufactured by SHIMADZU CORPORATION) can be used as a measuring instrument.

As the graphite particles in this example, graphite (FormulaBT 1520T manufactured by Superior Graphite Co.) having an average particle diameter of 20 μm was used. This graphite is obtained by coating spherical natural graphite with low crystalline carbon.

As the binder in this example, polyglutamic acid (manufactured by Nippon Poly-Glu Co., Ltd.) was used. Polyglutamic acid (also referred to as PGA) was used without neutralization. This polyglutamic acid has hydrophilicity and contains γ-polyglutamic acid as the main component. Furthermore, polyglutamic acid that is a crosslinking substance was used. The crosslinking substance can be prepared by irradiating γ-polyglutamic acid or its salt. Irradiation can cause a dehydrogenation reaction and produce a radiation crosslinking substance having large molecular weight. The average molecular weight of cross-linking polyglutamic acid can be several tens of millions.

A negative electrode is formed in such a manner that graphite particles, silicon particles, a binder, and acetylene black are mixed at predetermined amounts, deionized water is added to the mixture to form slurry, the slurry is applied over a current collector (copper foil) and dried, and pressing is performed. Polyglutamic acid is a polar polymer and has hydrophilicity, and thus can be dissolved in deionized water.

In this example, Sample 1 that is a half cell including a negative electrode was prepared; in the negative electrode, the weight ratios of silicon particles, graphite particles, a binder, and acetylene black were set to 9 wt %, 81 wt %, 7.5 wt %, and 2.5 wt %, respectively, the powders were mixed, deionized water was added to the mixture to form slurry, and the slurry was applied over a current collector. Note that heating was sufficiently performed after the application to evaporate a solvent component (moisture). The carried amount of the negative electrode was adjusted to be greater than or equal to 3.8 mg/cm² and less than or equal to 4.2 mg/cm². In this specification, the carried amount refers to weight of a negative electrode active material per unit surface area of a negative electrode current collector.

The conditions of a half cell are described below.

A positive electrode can and a negative electrode can that were formed of stainless steel (SUS) were used.

A lithium metal was prepared as a counter electrode and a coin-type half cell having the above negative electrode structure was formed. In the half cell, the lithium metal functions as a negative electrode and the above-described negative electrode functions as a positive electrode. Twelve samples of coin cells were formed.

Sample 2 was prepared in which the weight ratios of silicon particles, graphite particles (GP), a binder, and acetylene black were set to 8.5 wt %, 76.5 wt %, 10 wt %, and 5 wt %, respectively, and Sample 3 was prepared in which the weight ratios of silicon particles, graphite particles, a binder, and acetylene black were set to 9 wt %, 81 wt %, 10 wt %, and 0 wt %, respectively. Furthermore, Sample 4 was prepared in which the weight ratios of silicon particles, graphite particles, a binder, and acetylene black were set to 8 wt %, 72 wt %, 14 wt %, and 6 wt %, respectively. Sample 5 was prepared in which the weight ratios of silicon particles, graphite particles, a binder, and acetylene black were set to 7.6 wt %, 68.4 wt %, 18 wt %, and 6 wt %, respectively, and Sample 6 was prepared in which the weight ratios of silicon particles, graphite particles, a binder, and acetylene black were set to 6.8 wt %, 61.2 wt %, 24 wt %, and 8 wt %, respectively. Table 1 shows the measurement results.

TABLE 1

| | | | | | Charge |
|---|---|---|---|---|---|
| | | | | | capacity |
| | Si | GP | PGA | AB | (mAh/g) |
| Sample 1 | 9 wt % | 81 wt % | 7.5 wt % | 2.5 wt % | 616.2 |
| Sample 2 | 8.5 wt % | 76.5 wt % | 10 wt % | 5 wt % | 646.5 |
| Sample 3 | 9 wt % | 81 wt % | 10 wt % | 0 | 558.0 |
| Sample 4 | 8 wt % | 72 wt % | 14 wt % | 6 wt % | 644.9 |
| Sample 5 | 7.6 wt % | 68.4 wt % | 18 wt % | 6 wt % | 623.8 |
| Sample 6 | 6.8 wt % | 61.2 wt % | 24 wt % | 8 wt % | 647.5 |

In Table 1, each sample except Sample 3 not containing AB shows a favorable charge capacity value of greater than 600 mAh/g.

Furthermore, Sample 7 was prepared in which the weight ratios of silicon particles (Si), graphite particles (GP), and a binder (PGA) were set to 9 wt %, 81 wt %, and 10 wt %, respectively. Sample 8 was prepared in which the weight ratios of silicon particles, graphite particles, and a binder were set to 20 wt %, 70 wt %, and 10 wt %, respectively. Sample 9 was prepared in which the weight ratios of silicon particles, graphite particles, and a binder were set to 30 wt %, 50 wt %, and 20 wt %, respectively. Sample 10 was prepared in which the weight ratios of silicon particles, graphite particles, a binder, and AB were set to 30 wt %, 50 wt %, 10 wt %, and 10 wt %, respectively. Table 2 shows the measurement results of the prepared samples.

TABLE 2

| | | | | | Charge capacity |
|---|---|---|---|---|---|
| | Si | GP | PGA | AB | (mAh/g) |
| Sample 7 | 9 wt % | 81 wt % | 10 wt % | 0 | 558 |
| Sample 8 | 20 wt % | 70 wt % | 10 wt % | 0 | 881 |
| Sample 9 | 30 wt % | 50 wt % | 20 wt % | 0 | 1377 |
| Sample 10 | 30 wt % | 50 wt % | 10 wt % | 10 wt % | 1743 |

In Table 2, Sample 10 shows a favorable charge capacity value of greater than 1700 mAh/g.

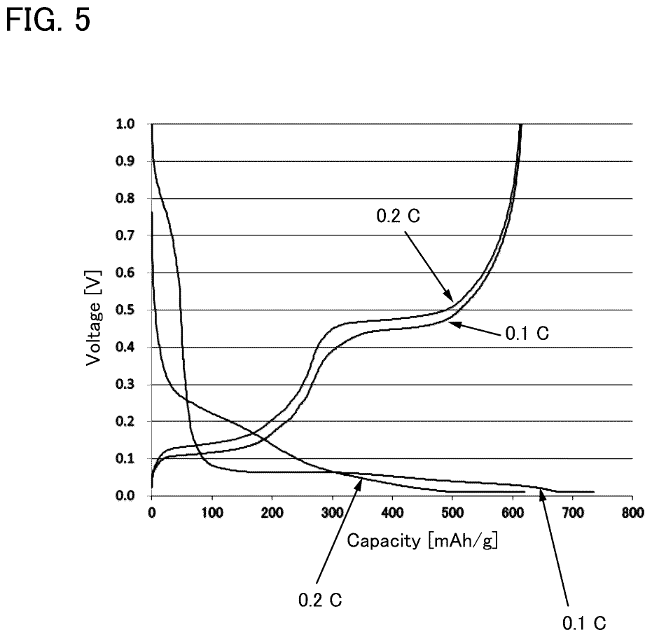

Furthermore, Sample 11 was prepared in which the weight ratio of silicon particles, graphite particles, polyglutamic acid, and acetylene black was set to 8:72:14:6, and FIG. 5 shows the charge and discharge curve of Sample 11. FIG. 1A and FIG. 2 correspond to a top view photograph and a cross-sectional photograph of a negative electrode of Sample 11, respectively. To obtain the charge and discharge curve shown in FIG. 5, the half cell using Sample 11, at room temperature, was discharged from 1 V to 0.01 V at a constant current at a discharge rate of 0.1 C, and when the voltage reached 0.01 V, discharge was performed at a constant voltage (first discharge). After that, the half cell was charged to 1 V at a first charge rate of 0.1 C (first charge). The first discharge and the first charge are collectively regarded as one cycle. One-hour break was taken after that, and second discharge was performed at a discharge rate of 0.2 C and then discharge was performed at a constant current. After that, second charge was performed to 1 V at a charge rate of 0.2 C. Note that the charge rate 1C of Sample 11 was 754 mAh/g.

FIG. 5 shows only the first charge and discharge (0.1 C) and the second charge and discharge (0.2 C), i.e., two cycles in a charge and discharge test of Sample 11. The first charge amount of Sample 11 was 614.7 mAh/g. Note that the theoretical capacity of graphite is 372 mAh/g, and it is confirmed that mixing nanosilicon increases the capacity.

Note that porous polypropylene (PP) was used as a separator of Samples 1 to 11. In an electrolyte solution of Samples 1 to 11, as an ionic liquid, 1-ethyl-3-methylimidazolium bis(fluorosulfonyl)imide (EMI-FSI) in which lithium bis(fluorosulfonyl)imide (LiFSI) was dissolved was used. EMI that is a cation of the ionic liquid does not contain fluorine at a terminal. The concentration of a lithium salt in the electrolyte solution was 2.15 mol/L.

### Example 2

In this example, the cycle performance of Sample 11 in Example 1 was measured.

### Charge and Discharge Cycle Test

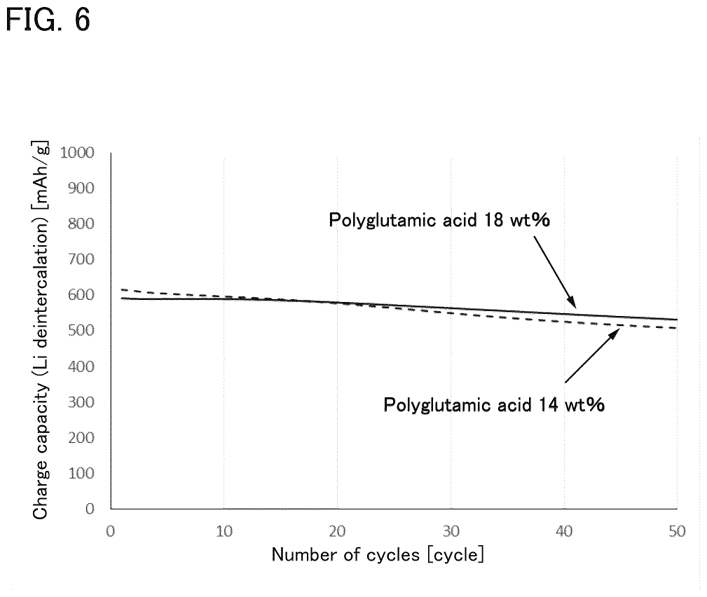

A charge and discharge cycle test was performed on the coin-type half cell formed above. Although two cycles were performed in Example 1, 50 cycles were performed in Example 2. The results are shown in FIG. 6.

As described in Example 1, one-hour break was taken between the first cycle and the second cycle. Ten-minute break was taken between the second cycle and the third cycle. Ten-minute break was taken between cycles after the third cycle. Furthermore, the cycle test was performed at a charge rate of 0.2 C and a discharge rate of 0.2 C after the third cycle.

FIG. 6 further shows the cycle performance of Sample 12 in which the weight ratio of polyglutamic acid is 18 wt %. In Sample 12, the weight ratio of silicon particles, graphite particles, polyglutamic acid, and acetylene black is 7.6:68.4:18:6. The first charge amount of Sample 12 was 591.7 mAh/g. The result shows that although Sample 11 has a higher first charge amount than Sample 12, Sample 12 has a more preferable cycle retention rate than Sample 11.

As shown in FIG. 6, even when the proportion of polyglutamic acid that is a binder is increased, the capacity is not decreased and a significant improvement in characteristics can be confirmed.

Although test results of the half cells were shown in this example, the similar effects can be obtained even with full cells. Note that a full cell is formed by using a positive electrode containing a positive electrode active material and a negative electrode having the above negative electrode structure.

In this specification, a charge voltage and a discharge voltage are voltages in the case of using a counter electrode of lithium, unless otherwise specified. Note that even when the same negative electrode is used, the charge and discharge voltages of a secondary battery vary depending on the material used for the positive electrode.

Furthermore, as a comparative example, a comparative sample below was formed.

Graphite (G10) having an average particle diameter of 10 μm and silicon particles having an average particle diameter of greater than or equal to 5 μm were mixed, polyimide was used as a binder to form slurry, and the slurry was applied over a copper current collector. The weight ratio of a silicon particle, graphite, polyimide, and acetylene black was adjusted to be 9.6:86.4:3:1.

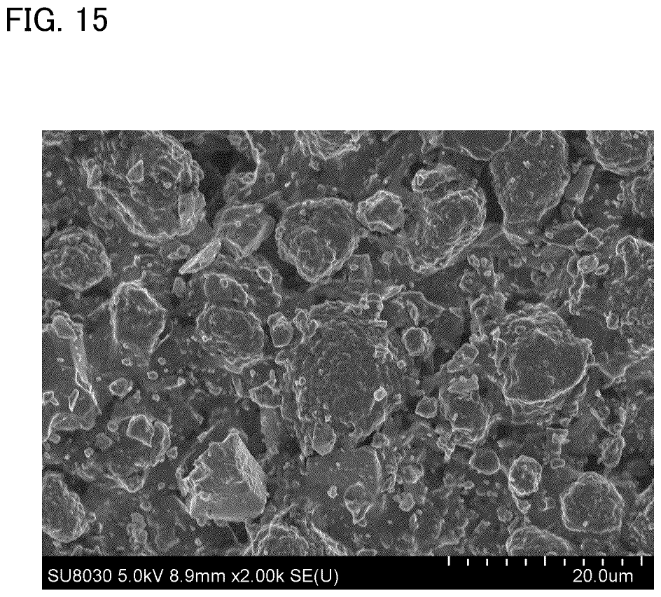

As a solvent of the slurry, N-methyl-2-pyrrolidone (NMP) was used. After the current collector was coated with the slurry, the solvent was volatilized. Through the above steps, a negative electrode was obtained. FIG. 15 is a top view photograph of the negative electrode.

A sheet of porous polyimide was used as a separator.

A lithium metal was used for a positive electrode. As the electrolyte, a mixed solution of ethylene carbonate (EC) and diethyl carbonate (DEC) in which 1 mol/L of LiPF₆ (lithium hexafluorophosphate) was dissolved was used. The compounding ratio was EC:DEC=3:7 (volume ratio).

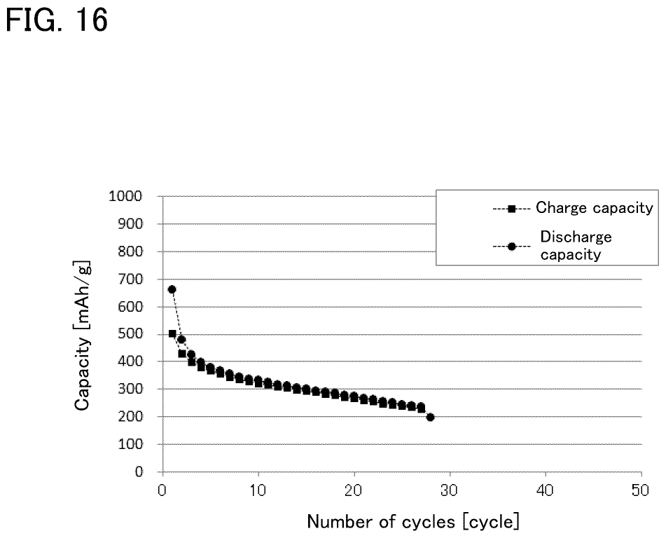

FIG. 16 shows cycle performance of the comparative sample. As shown in FIG. 16, the characteristics of the comparative sample is drastically decreased.

This application is based on Japanese Patent Application Serial No. 2022-097849 filed with Japan Patent Office on Jun. 17, 2022, the entire contents of which are hereby incorporated by reference.

What is claimed is:

1. A secondary battery comprising:
a positive electrode;
a negative electrode;
a separator between the positive electrode and the negative electrode; and
an electrolyte solution between the positive electrode and the negative electrode,
wherein the negative electrode comprises a graphite particle, a silicon particle with a smaller particle diameter than the graphite particle, and a binder, and
wherein the binder contains glutamic acid.

2. The secondary battery according to claim 1,
wherein an average particle diameter of the silicon particle is less than 1 μm.

3. The secondary battery according to claim 1,
wherein an average particle diameter of the graphite particle is greater than or equal to 5 μm.

4. The secondary battery according to claim 1,
wherein a weight ratio of the silicon particle is less than a weight ratio of the graphite particle.

5. The secondary battery according to claim 1,
wherein the negative electrode further contains acetylene black, and
wherein a weight ratio of the acetylene black is less than or equal to a weight ratio of the silicon particle.

6. The secondary battery according to claim 1,
wherein the electrolyte solution comprises an ionic liquid.

7. The secondary battery according to claim 1,
wherein the electrolyte solution comprises an organic solvent.

8. A method for forming a negative electrode active material layer, comprising the steps of:
forming a mixture by mixing a binder containing glutamic acid, a graphite particle, and a silicon particle;
preparing slurry by mixing the mixture and a solvent; and
applying the slurry over a current collector.

9. The method according to claim 8,
wherein a weight ratio of the silicon particle is less than a weight ratio of the graphite particle.

10. The method according to claim 8,
wherein a weight ratio of the binder is less than a weight ratio of the graphite particle, and
wherein a weight ratio of the binder to a sum of the graphite particle and the binder is greater than 5 wt %.
